(19) United States
(12) Patent Application Publication
(10) Pub. No.: US 2021/0374452 A1
(43) Pub. Date: Dec. 2, 2021

(54) METHOD AND DEVICE FOR IMAGE PROCESSING, AND ELECRTONIC EQUIPMENT

(71) Applicant: SHANGHAI SENSETIME INTELLIGENT TECHNOLOGY CO., LTD., Shanghai (CN)

(72) Inventors: Yizhi CHEN, Shanghai (CN); Chang LIU, Shanghai (CN); Yunhe GAO, Shanghai (CN); Liang ZHAO, Shanghai (CN)

(21) Appl. No.: 17/399,121

(22) Filed: Aug. 11, 2021

Related U.S. Application Data
(63) Continuation of application No. PCT/CN2019/114498, filed on Oct. 30, 2019.

(30) Foreign Application Priority Data
May 31, 2019 (CN) 201910473265.6

(51) Int. Cl. G06K 9/32; G06T 5/50; G06T 3/40; G06N 3/08; G06N 3/04

(52) U.S. Cl. CPC G06K 9/32; G06T 5/50; G06N 3/0454; G06N 3/08; G06T 3/4046

(57) ABSTRACT

Image data including a target object is acquired. The target object includes at least one sub-object. Target image data is acquired by processing the image data based on a fully convolutional neural network. The target image data include at least a center point of each sub-object in the target object.

### CROSS-REFERENCE TO RELATED APPLICATIONS

This application is a continuation of International Application No. PCT/CN2019/114498, filed on Oct. 30, 2019, which per se is based on, and claims benefit of priority to, Chinese Application No. 201910473265.6, filed on May 31, 2019. The disclosures of International Application No. PCT/CN2019/114498 and Chinese Application No. 201910473265.6 are hereby incorporated by reference in their entireties.

### TECHNICAL FIELD

The subject disclosure relates to the field of image processing, and more particularly, to a method and device for image processing, and electronic equipment.

### BACKGROUND

In general, a human spine consists of 26 vertebrae arranged sequentially from top to bottom. The vertebrae are important reference objects for human body location. Detecting, locating, and identifying centers of the 26 vertebrae may provide relative location information for locating another organ or tissue, thereby facilitating a subsequent activity such as a surgical plan, a pathological test, a postoperative evaluation, etc. On the other hand, to detect and locate the center of a vertebra, mathematical modeling may be performed on the spine, thereby providing a priori information about the shape of the vertebra, facilitating segmentation of other tissues of the spine. Therefore, it is of important application merit to locate the center of a vertebra.

At present, the center of a vertebra may be located mainly in a manual manner or using an automatic diagnosis system. However, identifying the type of a vertebra and locating the center of the vertebra in a three-dimensional Computed Tomography (CT) image can be very time-consuming and laborious, and tends to generate a human error. In some difficult and complicated images, manual location may be somehow subjective and may cause an error. Yet an algorithm used in an existing automatic diagnosis system is characterized by manual selection, leading to poor generalization performance, resulting in poor system performance, as well as inaccurate vertebra center location.

### SUMMARY

Embodiments herein provide a method and device for image processing, and electronic equipment.

A technical solution herein is implemented as follows.

According to an aspect herein, a method for image processing includes: acquiring image data including a target object, the target object including at least one sub-object; and acquiring target image data by processing the image data based on a fully convolutional neural network. The target image data include at least a center point of each sub-object in the target object.

According to embodiments herein, a device for image processing includes an acquiring unit and an image processing unit. The acquiring unit is adapted to acquiring image data including a target object. The target object includes at least one sub-object. The image processing unit is adapted to acquiring target image data by processing the image data based on a fully convolutional neural network. The target image data include at least a center point of each sub-object in the target object.

According to embodiments herein, a non-transitory computer-readable storage medium has stored thereon a computer program which, when executed by a processor, implements steps of a method herein.

According to embodiments herein, electronic equipment includes memory, a processor, and a computer program stored on the memory and executable by the processor. When executing the computer program, the processor implements steps of a method herein.

Embodiments herein provide a method and device for image processing, and electronic equipment. The method includes: acquiring image data including a target object, the target object including at least one sub-object; and acquiring target image data by processing the image data based on a fully convolutional neural network. The target image data include at least a center point of each sub-object in the target object. With a technical solution herein, image data are processed through a fully convolutional neural network, acquiring target image data including at least the center point of at least one sub-object in the target object, such as target image data including at least the center point of each vertebra in the spine bones. On one hand, compared to manual feature selection, feature identification, selection, and categorization may be performed automatically on image data through a first fully convolutional neural network, improving system performance, improving accuracy in identifying a center point of a vertebra. On the other hand, each pixel may be categorized with a fully convolutional neural network. That is, with the fully convolutional neural network, training efficiency as well as network performance may be improved by taking advantage of a spatial relation between the vertebrae.

### BRIEF DESCRIPTION OF THE ACCOMPANYING DRAWINGS

FIG. 1 is a first flowchart of a method for image processing according to an exemplary embodiment herein.

FIG. 2 is a second flowchart of a method for image processing according to an exemplary embodiment herein.

FIG. 3 is a third flowchart of a method for image processing according to an exemplary embodiment herein.

FIG. 4 is a diagram of applying a method for image processing according to an exemplary embodiment herein.

FIG. 5 is a flowchart of a network training method in a method for image processing according to an exemplary embodiment herein.

FIG. 6 is another flowchart of a network training method in a method for image processing according to an exemplary embodiment herein.

FIG. 7 is a first diagram of a structure of a device for image processing according to an exemplary embodiment herein.

FIG. 8 is a second diagram of a structure of a device for image processing according to an exemplary embodiment herein.

FIG. 9 is a third diagram of a structure of a device for image processing according to an exemplary embodiment herein.

FIG. 10 is a fourth diagram of a structure of a device for image processing according to an exemplary embodiment herein.

FIG. 11 is a fifth diagram of a structure of a device for image processing according to an exemplary embodiment herein.

FIG. 12 is a diagram of a structure of electronic equipment according to an exemplary embodiment herein.

### DETAILED DESCRIPTION

The subject disclosure is further elaborated below with reference to the drawings and embodiments.

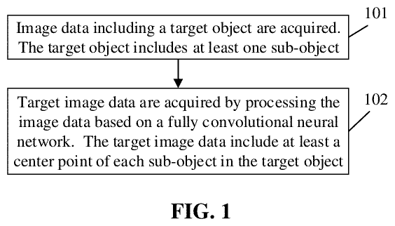

Embodiments herein provide a method for image processing. FIG. 1 is a first flowchart of a method for image processing according to an exemplary embodiment herein. As shown in FIG. 1, the method includes a step as follows.

In S101, image data including a target object are acquired. The target object includes at least one sub-object.

In S102, target image data are acquired by processing the image data based on a fully convolutional neural network. The target image data include at least a center point of each sub-object in the target object.

In S101 herein, the image data may be image data including a target object. The image data herein may be 3D image data including a target object. In embodiments herein, the target object may include spine bones. The spine bones may include at least one vertebra. In embodiments below, as an example, description may be made taking the target object as spine bones. In other embodiments, the target object is not limited to spine bones, which is not limited hereto.

As an example, the image data may be 3D image data including spine bones as acquired through imaging technology. For example, the image data may be Computed Tomography (CT) image data including spine bones, Nuclear Magnetic Resonance Imaging (MRI) image data, etc. Of course, the image data herein are not limited to image data acquired in an aforementioned mode. Any 3D image data of spine bones acquired through imaging technology may be the image data herein.

Spine bones herein may include, but are not limited to, spine bones of human being, but may also be spine bones of another animal with a spine. In general, taking a human being as an example, there may be 26 spine bones, including 24 vertebrae (7 cervical vertebrae, 12 thoracic vertebrae, and 5 lumbar vertebrae), 1 sacrum, and 1 coccyx. The image data herein may include at least some of the 26 spine bones. Understandably, the image data may include the complete spine, or may include just some vertebrae. When the image data include just some vertebrae, it may be more difficult to categorize the vertebrae. That is, it may be more difficult to determine which vertebra center point belongs to which vertebra.

In S102 herein, the target image data may be acquired by processing the image data based on the fully convolutional neural network, as follows. The image data may be input, as input data, to a trained fully convolutional neural network, acquiring the target image data comprising at least a center point of each sub-object in the target object.

For example, the target object may be spine bones. With the embodiments, the image data may be processed via a fully convolutional neural network, acquiring the target image data comprising at least a center point of each vertebra in the spine bones. On one hand, compared to a manner of manually selecting a feature, feature identification, feature selection, and feature categorization may be performed automatically on the image data via the fully convolutional neural network, improving system performance, improving accuracy in locating a center point of a vertebra. On the other hand, each pixel may be categorized using the fully convolutional neural network. That is, with the fully convolutional neural network, training efficiency as well as network performance may be improved by taking advantage of a spatial relation between the vertebrae.

Based on S101 to S102 in the embodiment, embodiments herein may further provide a method for image processing. In the embodiments, S102 may be elaborated further. Specifically, in S102, the target image data may be acquired by processing the image data based on the fully convolutional neural network, as follows. The target image data may be acquired by processing the image data based on a first fully convolutional neural network. The target image data may include the center point of the each sub-object in the target object.

In the embodiments, the target object may be spine bones, for example. The center point of each vertebra in the spine bones may be located through the first fully convolutional neural network. Understandable, the first fully convolutional neural network may be acquired by being trained in advance. Target image data including the center point of each vertebra in the spine bones may be acquired by inputting the image data to the first fully convolutional neural network. Accordingly, the location of the center point of each vertebra may be determined through the target image data. In this way, after acquiring the target image data, a user (such as a professional doctor) may determine, based on a rule of thumb, a category of a vertebra to which a center point belongs. That is, a category of a vertebra corresponding to a center point may be determined manually.

In an optional embodiment herein, the first image data may be acquired by processing the image data based on the first fully convolutional neural network as follows. First displacement data corresponding to a pixel in the image data may be acquired by processing the image data based on the first fully convolutional neural network. The first displacement data may represent a displacement between the pixel and a center point of a first sub-object closest to the pixel. An initial location of the center point of the first sub-object closest to the pixel may be determined based on the first displacement data and location data of the pixel. The first sub-object may be any sub-object in the at least one sub-object. Initial locations of the center point of the first sub-object corresponding to at least some pixels in the image data may be acquired. A count of occurrences of each of the initial locations may be determined. The center point of the first sub-object may be determined based on an initial location with a maximal count. Target image data may be acquired based on the center point of the first sub-object as determined.

In the embodiment, the image data including the spine bones may be processed through the trained first fully convolutional neural network, acquiring first displacement data between a pixel in the image data and a center point of a vertebra closest to the pixel. The first displacement data may include x-axis displacement data, y-axis displacement data, and z-axis displacement data. An initial location of the center point of the vertebra closest to the pixel may be determined based on the location of the pixel and the first displacement data corresponding to the pixel. Understandably, for each pixel, an initial location of the center point of the vertebra closest to the pixel may be determined. Multiple initial locations corresponding to a same vertebra may be determined based on some pixels in the image data. Some of the multiple initial locations as determined may be identical, while the others of the multiple initial locations may differ from each other. Accordingly, in the embodiment, a poll may be conducted, that is, identical initial locations may be counted. For example, there may be 100 initial locations, including 50 occurrences of an initial location a, 20 occurrences of an initial location b, 15 occurrences of an initial location c, 10 occurrences of an initial location d, and 5 occurrences of an initial location e. Then, the initial location a may be determined as the location of the center point of the vertebra.

As an implementation, the method may include a step as follows. Before determining the initial location of the center point of the first sub-object closest to the pixel based on the first displacement data and the location data of the pixel, at least one first pixel may be acquired by filtering at least one pixel in the image data based on a first displacement distance corresponding to the at least one pixel. A distance between the at least one first pixel and a center point of a first sub-object closest to the at least one pixel may meet a specified condition. The initial location of the center point of the first sub-object closest to the pixel may be determined based on the first displacement data and the location data of the pixel, as follows. The initial location of the center point of the first sub-object may be determined based on first displacement data corresponding to the at least one first pixel and location data of the at least one first pixel.

In the embodiment, before determining the initial location of the center point of a vertebra, pixels involved in initial location determination may be filtered first. That is, not all pixels in the image data have to be involved in determining the initial location of the center point of the vertebra. Specifically, as the first displacement distance corresponding to a pixel may represent a displacement between the pixel and a center point of a vertebra closest to the pixel, only pixels located within a range from the center point of the vertebra may be used in determining the initial location of the center point of the vertebra.

As an implementation, the at least one first pixel, with the distance to the center point of the first sub-object closest to the at least one pixel meeting the specified condition, may be acquired as follows. The at least one first pixel, with the distance to the center point of the first sub-object closest to the at least one pixel being less than a preset threshold, may be acquired. In actual application, as the first displacement data may include the x-axis displacement data, the y-axis displacement data, and the z-axis displacement data, it may be determined whether the x-axis displacement data, values of the y-axis displacement data, and the z-axis displacement data in the first displacement data are each less than the preset threshold. When the x-axis displacement data, values of the y-axis displacement data, and the z-axis displacement data in the first displacement data are each less than the preset threshold, it means that the pixel is a first pixel meeting the specified condition. The initial location of the center point of the first sub-object may be determined according to first displacement data corresponding to at least one first pixel and location data of the at least one first pixel. In this way, the amount of data to be processed may be reduced greatly.

With the embodiment, the image data are processed through a first fully convolutional neural network, acquiring target image data including at least the center point of at least one sub-object in the target object, such as target image data including at least the center point of each vertebra in the spine bones. On one hand, compared to manual feature selection, feature identification, selection, and categorization may be performed automatically on image data through a first fully convolutional neural network, improving system performance, improving accuracy in identifying a center point of a vertebra. On the other hand, each pixel may be categorized with a fully convolutional neural network. That is, with the first fully convolutional neural network, training efficiency as well as network performance may be improved by taking advantage of a spatial relation between the vertebrae.

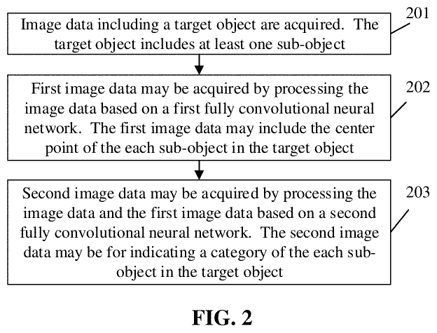

Embodiments herein may further provide a method for image processing. FIG. 2 is a second flowchart of a method for image processing according to an exemplary embodiment herein. As shown in FIG. 2, the method includes a step as follows.

In S201, image data including a target object are acquired. The target object includes at least one sub-object.

In S202, first image data may be acquired by processing the image data based on a first fully convolutional neural network. The first image data may include the center point of the each sub-object in the target object.

In S203, second image data may be acquired by processing the image data and the first image data based on a second fully convolutional neural network. The second image data may be for indicating a category of the each sub-object in the target object.

One may refer to elaboration of S101 in an aforementioned embodiment for elaboration of S201 in the embodiment, which is not repeated here to save space.

In S202 here, the center point of each vertebra in the spine bones may be located through the first fully convolutional neural network. Understandable, the first fully convolutional neural network may be acquired by being trained in advance. First image data including the center point of each vertebra in the spine bones may be acquired by inputting the image data to the first fully convolutional neural network. Accordingly, the location of the center point of each vertebra may be determined through the first image data.

In an optional embodiment herein, the first image data may be acquired by processing the image data based on the first fully convolutional neural network as follows. First displacement data corresponding to a pixel in the image data may be acquired by processing the image data based on the first fully convolutional neural network. The first displacement data may represent a displacement between the pixel and a center point of a first sub-object closest to the pixel. An initial location of the center point of the first sub-object closest to the pixel may be determined based on the first displacement data and location data of the pixel. The first sub-object may be any sub-object in the at least one sub-object. Initial locations of the center point of the first sub-object corresponding to at least some pixels in the image data may be acquired. A count of occurrences of each of the initial locations may be determined. The center point of the first sub-object may be determined based on an initial location with a maximal count. The first image data may be acquired based on the center point of the first sub-object as determined.

In the embodiment, the image data including the spine bones may be processed through the trained first fully convolutional neural network, acquiring first displacement data between a pixel in the image data and a center point of a vertebra closest to the pixel. The first displacement data may include x-axis displacement data, y-axis displacement data, and z-axis displacement data. An initial location of the center point of the vertebra closest to the pixel may be determined based on the location of the pixel and the first displacement data corresponding to the pixel. Understandably, for each pixel, an initial location of the center point of the vertebra closest to the pixel may be determined. Multiple initial locations corresponding to a same vertebra may be determined based on some pixels in the image data. Some of the multiple initial locations as determined may be identical, while the others of the multiple initial locations may differ from each other. Accordingly, in the embodiment, a poll may be conducted, that is, identical initial locations may be counted. For example, there may be 100 initial locations, including 50 occurrences of an initial location a, 20 occurrences of an initial location b, 15 occurrences of an initial location c, 10 occurrences of an initial location d, and 5 occurrences of an initial location e. Then, the initial location a may be determined as the location of the center point of the vertebra.

As an implementation, the method may include a step as follows. Before determining the initial location of the center point of the first sub-object closest to the pixel based on the first displacement data and the location data of the pixel, at least one first pixel may be acquired by filtering at least one pixel in the image data based on a first displacement distance corresponding to the at least one pixel. A distance between the at least one first pixel and a center point of a first sub-object closest to the at least one pixel may meet a specified condition. The initial location of the center point of the first sub-object closest to the pixel may be determined based on the first displacement data and the location data of the pixel, as follows. The initial location of the center point of the first sub-object may be determined based on first displacement data corresponding to the at least one first pixel and location data of the at least one first pixel.

In the embodiment, before determining the initial location of the center point of a vertebra, pixels involved in initial location determination may be filtered first. That is, not all pixels in the image data have to be involved in determining the initial location of the center point of the vertebra. Specifically, as the first displacement distance corresponding to a pixel may represent a displacement between the pixel and a center point of a vertebra closest to the pixel, only pixels located within a range from the center point of the vertebra may be used in determining the initial location of the center point of the vertebra.

As an implementation, the at least one first pixel, with the distance to the center point of the first sub-object closest to the at least one pixel meeting the specified condition, may be acquired as follows. The at least one first pixel, with the distance to the center point of the first sub-object closest to the at least one pixel being less than a preset threshold, may be acquired. In actual application, as the first displacement data may include the x-axis displacement data, the y-axis displacement data, and the z-axis displacement data, it may be determined whether the x-axis displacement data, values of the y-axis displacement data, and the z-axis displacement data in the first displacement data are each less than the preset threshold. When the x-axis displacement data, values of the y-axis displacement data, and the z-axis displacement data in the first displacement data are each less than the preset threshold, it means that the pixel is a first pixel meeting the specified condition. The initial location of the center point of the first sub-object may be determined according to first displacement data corresponding to at least one first pixel and location data of the at least one first pixel. In this way, the amount of data to be processed may be reduced greatly.

To further determine to which vertebra a center point in the first image data belongs, in S203 here, each vertebra in the spine bones may be categorized through a second fully convolutional neural network, thereby determining the category of each vertebra in the image data, which is then mapped to a center point in the first image data, thereby determining the category of the vertebra to which the center point belongs. Understandable, the second fully convolutional neural network may be acquired by being trained in advance. Second image data for indicating the category of each vertebra in the spine bones may be acquired by inputting the image data and the first image data to the second fully convolutional neural network.

In an optional embodiment herein, the second image data may be acquired by processing the image data and the first image data based on the second fully convolutional neural network, as follows. The target image data may be acquired by merging the image data and the first image data. A probability of a category of a sub-object to which a pixel in the target image data belongs may be acquired by processing the target image data based on the second fully convolutional neural network. A category of the sub-object corresponding to a maximal probability may be determined as the category of the sub-object to which the pixel belongs. The second image data may be acquired based on the category of the sub-object to which the pixel in the target image data belongs.

In the embodiment, the second image data may be acquired by processing, based on a trained second fully convolutional neural network, the image data including the spine bones and the first image data including the center point of each vertebra in the spine bones, as follows. First, the image data and the first image data may be merged. In actual application, the merging may be performed for channel data corresponding to each pixel in the image data, acquiring the target image data. Then, the target image data may be processed through the second fully convolutional neural network, acquiring a probability of a category of a vertebra to which each pixel or some pixels in the target image data belong. A category of the vertebra corresponding to a maximal probability may be determined as the category of the vertebra to which the pixel(s) belong. For example, the probability of a pixel belonging to a first vertebra may be 0.01. The probability of the pixel belonging to a second vertebra may be 0.02. The probability of the pixel belonging to a third vertebra may be 0.2. The probability of the pixel belonging to a fourth vertebra may be 0.72. The probability of the pixel belonging to a fifth vertebra may be 0.15. The probability of the pixel belonging to a sixth vertebra may be 0.03, etc. The maximal probability may be determined to be 0.72. Then, it may be determined that the pixel belongs to the fourth vertebra.

In other embodiments, the category of a vertebra to which each pixel in the target image data belongs may be determined. Accordingly, at least one vertebra included in the spine bones may be segmented based on the category of the vertebra to which the each pixel belongs, thereby determining the at least one vertebra included in the target image data.

As an implementation, the probability of the category of the sub-object to which the pixel in the target image data belongs may be acquired and the category of the sub-object corresponding to the maximal probability may be determined as the category of the sub-object to which the pixel belongs as follows. A probability of a category of a sub-object to which a pixel belongs may be acquired. The pixel may correspond to a center point of a second sub-object in the target image data. The second sub-object may be any sub-object in the at least one sub-object. A category of a second sub-object corresponding to a maximal probability may be determined as the category of the second sub-object.

In the embodiment, with the implementation, the category of a vertebra to which a center point belongs may be determined directly, thereby determining the category of the vertebra including the center point.

As another implementation, the probability of the category of the sub-object to which the pixel in the target image data belongs may be acquired and the category of the sub-object corresponding to the maximal probability may be determined as the category of the sub-object to which the pixel belongs as follows. A first probability of a category of a sub-object to which a pixel belongs may be acquired. The pixel may correspond to a center point of a second sub-object in the target image data. A second probability of a category of a sub-object to which another pixel belongs may be acquired. The distance between the another pixel and the center point may be a specified threshold. A count of occurrences of a same value in the first probability and the second probability may be determined. A category of a second sub-object corresponding to a probability with a maximal count may be determined as the category of the second sub-object.

In the embodiment, the category of a vertebra may be determined through the center point of the vertebra and other pixels near the center point of the vertebra. In actual application, a category of a vertebra may be determined corresponding to each pixel. A category of the vertebra determined corresponding to the center point of the vertebra may differ from a category of the vertebra determined corresponding to a pixel near the center point of the vertebra. Accordingly, in the embodiment, a poll may be conducted, to count occurrences of a same category in the categories of the vertebra determined corresponding to the center point of the vertebra and to other pixels near the center point of the vertebra. For example, it may be determined that a count of a fourth vertebra is maximal. Then, it may be determined that the category of the vertebra is the fourth vertebra.

Understandably, the first image data and the second image data here may correspond to the target image data in an aforementioned embodiment. That is, there may be two pieces of target image data, including the first image data for determining the center point of a vertebra and the second image data for determining the category of the vertebra.

With the embodiment, the center point of each vertebra in spine bones included in the image data is located through a first fully convolutional neural network. The category of each vertebra in spine bones included in the image data is determined through a second fully convolutional neural network. That is, the center point of each vertebra is determined by processing local information of the image data through the first fully convolutional neural network, and the category of each vertebra is determined by processing global information of the image data through the second fully convolutional neural network. On one hand, compared to a manner of manually selecting a feature, feature identification, feature selection, and feature categorization may be performed automatically on the image data via a fully convolutional neural network (including the first fully convolutional neural network and the second fully convolutional neural network), improving system performance, improving accuracy in locating a center point of a vertebra. On the other hand, each pixel may be categorized using the fully convolutional neural network. That is, with the fully convolutional neural network, training efficiency may be improved by taking advantage of a spatial relation between the vertebrae, specifically by processing global information of the image data through the second fully convolutional neural network and training the second fully convolutional neural network according to a spatial relation among respective vertebrae in spine bones, improving network performance.

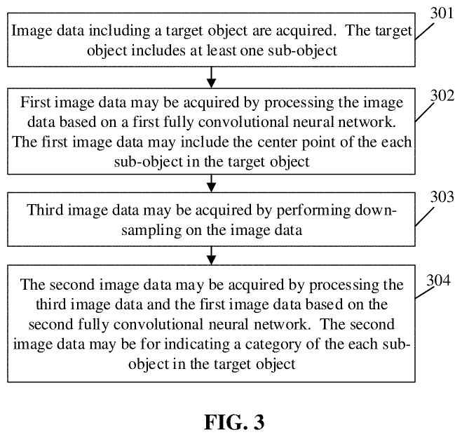

Based on an aforementioned embodiment, embodiments herein further provide a method for image processing. FIG. 3 is a third flowchart of a method for image processing according to an exemplary embodiment herein. The method may include a step as follows.

In S301, image data including a target object are acquired. The target object includes at least one sub-object.

In S302, first image data may be acquired by processing the image data based on a first fully convolutional neural network. The first image data may include the center point of the each sub-object in the target object.

In S303, third image data may be acquired by performing down-sampling on the image data.

In S304, the second image data may be acquired by processing the third image data and the first image data based on the second fully convolutional neural network. The second image data may be for indicating a category of the each sub-object in the target object.

One may refer to elaboration of S201 to S202 for elaboration of S301 to S302 in the embodiment, which is not repeated here to save space.

The difference here as compared to an aforementioned embodiment lies in that in the embodiment, before acquiring the second image data based on the second fully convolutional neural network, down-sampling may be performed on the image data, i.e., to reduce the image data, acquiring third image data. The third image data and the first image data may be input to the second fully convolutional neural network, acquiring the second image data. Reducing the image data may reduce the amount of data, thereby solving the problem of limited memory, as well as improving system performance greatly by integrating global information of the image (vertebra association information, i.e., vertebra context information).

A solution for image processing herein is elaborated below with reference to a specific scene of application.

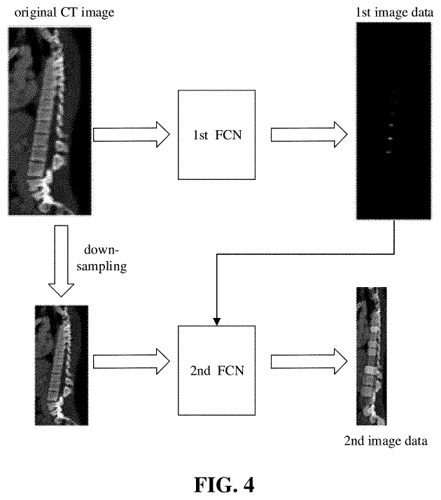

FIG. 4 is a diagram of applying a method for image processing according to an exemplary embodiment herein. In a scene shown in FIG. 4, a patient with a damaged spine goes to a hospital for treatment, and gets a CT image (such as a 3D image) of the spine photographed. A doctor may locate the center point of a vertebra in the CT image through a solution for image processing herein.

Specifically, as shown in FIG. 4, assume that the photographed CT image is denoted by an original CT image. On one hand, the first image data may be acquired by processing the original CT image through the first fully convolutional neural network. The first image data may include the center point of each vertebra in the spine bones. As the center point of the each vertebra exists independently and is not affected by another vertebra, the center point of a vertebra may be determined through the first fully convolutional neural network, given the image of the vertebra and its vicinity. The center point of a vertebra may have to be determined through information on a detail such as a boundary of the vertebra. Accordingly, the center point of each vertebra in the original CT image may be located through the first fully convolutional neural network, and the center point of the each vertebra may be located through the original CT image that retains more details. Understandably, the first fully convolutional neural network may be used for processing local information.

On the other hand, to reduce the amount of data and solve the problem of limited memory, with the embodiment, sampling processing may be performed on the original CT image, acquiring a reduced CT image. The reduce CT image and the first image data may be process through a second fully convolutional neural network, acquiring second image data. The second image data may be used for indicating the category of each vertebra in the spine bones.

In an implementation, the category of a vertebra, to which a center point determined in the first image data belongs, may be determined by way of a rule of thumb. However, if a vertebra is missing in the original CT image, or a result of locating the center point of the vertebra using the first image data acquired through the first fully convolutional neural network is poor and the center points of some vertebrae are missing, there may be a problem of whether the category of a vertebra, to which a center point of the vertebra belongs, exists. Accordingly, in the embodiment, it is proposed to determine the category of a vertebra through the second fully convolutional neural network. To determine the category of a vertebra, a relation between the location of the vertebra and locations of other vertebrae may have to be considered comprehensively. Therefore, understandably, the second fully convolutional neural network may be used for processing global information. In actual application, a convolution kernel in a fully convolutional neural network may have a limited receptive field. If an input image is excessively large, the convolution kernel may not be able to perceive the whole image, thereby failing to integrate global information of the image. On the other hand, vertebra categorization may require considering a respective relation between a vertebra and other vertebrae, while details around the vertebra are trivial. Therefore, in the embodiment, the original CT image may be reduced, by way of down-sampling, as input data for determining the category of a vertebra.

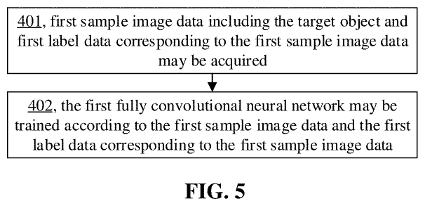

As to training of the first fully convolutional neural network, FIG. 5 is a flowchart of a network training method in a method for image processing according to an exemplary embodiment herein. As shown in FIG. 5, the method may include a step as follows.

In S401, first sample image data including the target object and first label data corresponding to the first sample image data may be acquired. The first label data may be for indicating the center point of the each sub-object in the target object in the first sample image data.

In S402, the first fully convolutional neural network may be trained according to the first sample image data and the first label data corresponding to the first sample image data.

In embodiments herein, the target object may include spine bones. The spine bones may include at least one vertebra.

In S401 herein, the first sample image data and the first label data corresponding to the first sample image data may be data for training the first fully convolutional neural network. The first sample image data may include a target object. The target object may be spine bones, for example. In actual application, to train the first fully convolutional neural network, multiple pieces of the first sample image data may be acquired in advance. The multiple pieces of the first sample image data may include spine bones of a same category. The category may be a human being, or an animal with spine bones, etc., for example. Understandable, the multiple pieces of the first sample image data acquired may be sample image data including spine bones of a human being. Alternatively, the multiple pieces of the first sample image data acquired may be sample image data including spine bones of a certain breed of dog, etc.

The first label data may label the center point of each vertebra in spine bones in the first sample image data. As an example, the first label data may be coordinate data corresponding to the center point of each vertebra. As another example, the first label data may also be image data including the center point of each vertebra that correspond to the first sample image data.

In S402 herein, the first fully convolutional neural network may be trained according to the first sample image data and the first label data corresponding to the first sample image data as follows. Initial image data may be acquired by processing the first sample image data according to the first fully convolutional neural network. The initial image data may include an initial center point of the each sub-object in the target object in the first sample image data. The first fully convolutional neural network may be trained by determining a loss function based on the initial image data and the first label data and adjusting a parameter of the first fully convolutional neural network based on the loss function.

In the embodiment, when training the first fully convolutional neural network, the first sample image data may be input to the first fully convolutional neural network. The first sample image data may be processed according to an initial parameter through the first fully convolutional neural network, acquiring the initial image data. The initial image data may include an initial center point of each vertebra in spine bones in the first sample image data. In general, the acquired initial center point of a vertebra may differ from the center point of the vertebra in the first label data. In the embodiment, the loss function may be determined based on the difference. The parameter of the first fully convolutional neural network may be adjusted based on the loss function determined, thereby training the first fully convolutional neural network. Understandably, a difference between the center point of the vertebra determined by the trained first fully convolutional neural network and the center point of the vertebra in the first label data may meet a preset condition. The preset condition may be a preset threshold. For example, a displacement between the center point of the vertebra determined by the trained first fully convolutional neural network and the center point of the vertebra in the first label data may be less than the preset threshold.

As an implementation, the loss function may be determined based on the initial image data and the first label data as follows. A first set of displacements may be determined based on first location information of the initial center point of a vertebra in the initial image data and second location information of the center point of the vertebra in the first label data. The first set of displacements may include displacements in 3 dimensions. It may be determined, based on the first set of displacements, whether the initial center point of the vertebra falls within a set distance range from the center point of the vertebra in the first label data, acquiring a first result. The loss function may be determined based on the first set of displacements and/or the first result.

In the embodiment, a parameter of an untrained first fully convolutional neural network may not be optimal. Therefore, the initial center point of a vertebra in the initial image data may differ from the accurate center point. In the embodiment, 3D image data may be processed using the first fully convolutional neural network. Therefore, the acquired first location information of the initial center point may include data in three dimensions. Assume that axes x and y are established in a horizontal plane, and an axis z is established along a direction perpendicular to the horizontal plane, generating a 3D coordinate system xyz. Then, the first location information may be 3D coordinate data (x, y, z) in the 3D coordinate system xyz. Correspondingly, the center point of the vertebra in the first label data may be expressed as 3D coordinate data (x′, y′, z′). Then, the first set of displacements may be expressed as ((x′-x), (y′-y), (z′-z)). Moreover, it may be determined, through the first set of displacements, whether the initial center point falls within the preset distance range from the center point of the vertebra in the first label data. The loss function determined here may be related to the first set of displacements and/or the first result. Assume that the loss function relates to the first set of displacements and the first result. Then, the loss function may include four related parameters, namely, (x′-x), (y′-y), (z′-z), and the first result of whether the initial center point of the vertebra falls within the preset distance range from the center point of the vertebra in the first label data. In the embodiment, the parameter of the first fully convolutional neural network may be adjusted according to the loss function (such as the four related parameters in the loss function). In actual application, the parameter of the first fully convolutional neural network may have to be trained by adjusting the parameter for multiple times. A difference between the center point of a vertebra, acquired by processing the first sample image data with the final trained first fully convolutional neural network, and the center point of the vertebra in the first label data may fall in a preset threshold range.

In the embodiment, the first fully convolutional neural network may be a V-Net fully convolutional neural network with an encoder-decoder architecture.

With the embodiment, the center point of each vertebra in spine bones included in the image data is located through a first fully convolutional neural network. On one hand, compared to a manner of manually selecting a feature, feature identification, feature selection, and feature categorization may be performed automatically on the image data via the first fully convolutional neural network, improving system performance, improving accuracy in locating a center point of a vertebra. On the other hand, with the embodiment, end-to-end training of the first fully convolutional neural network allows to acquire the location of the center point of each vertebra accurately.

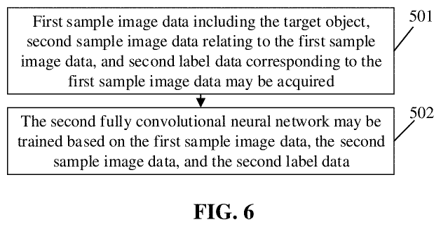

As to training of the second fully convolutional neural network, FIG. 6 is another flowchart of a network training method in a method for image processing according to an exemplary embodiment herein. As shown in FIG. 6, the method may include a step as follows.

In S501, first sample image data including the target object, second sample image data relating to the first sample image data, and second label data corresponding to the first sample image data may be acquired. The second sample image data may include the center point of the each sub-object in the target object in the first sample image data. The second label data may be for indicating the category of the each sub-object in the target object in the first sample image data.

In S502, the second fully convolutional neural network may be trained based on the first sample image data, the second sample image data, and the second label data.

In S501 herein, the first sample image data and the first label data corresponding to the first sample image data may be data for training the first fully convolutional neural network. The first sample image data may include a target object. The target object may be spine bones, for example. In actual application, to train the first fully convolutional neural network, multiple pieces of the first sample image data may be acquired in advance. The multiple pieces of the first sample image data may include spine bones of a same category. The category may be a human being, or an animal with spine bones, etc., for example. Understandable, the multiple pieces of the first sample image data acquired may be sample image data including spine bones of a human being. Alternatively, the multiple pieces of the first sample image data acquired may be sample image data including spine bones of a certain breed of dog, etc.

The second sample image data may include the center point of each sub-object (such as a vertebra) corresponding to the target object (such as spine bones) in the first sample image data. As an implementation, the second sample image data may be image data including the center point of a vertebra acquired by the trained first fully convolutional neural network.

The second label data may be data corresponding to the category of each vertebra in the first sample image data. As an example, the second label data may be the second image data shown in FIG. 4, i.e., image data generated by manually labeling a contour of a vertebra of each category.

In S502 here, the second fully convolutional neural network may be trained based on the first sample image data, the second sample image data, and the second label data as follows. Third sample image data may be acquired by performing down-sampling on the first sample image data. The second fully convolutional neural network may be trained based on the third sample image data, the second sample image data, and the second label data.

In the embodiment, to reduce the amount of data during network training, and solve the problem of limited memory, before training the second fully convolutional neural network, first, down-sampling may be performed on the first sample image data, acquiring third sample image data. The second fully convolutional neural network may be trained based on the third sample image data, the second sample image data, and the second label data. Similar to the way of training the first fully convolutional neural network, initial image data including an initial category of each vertebra may be acquired by processing the third sample image data and the second sample image data according to the second fully convolutional neural network. A loss function may be determined based on a difference between the initial image data and the second label data. The parameter of the second fully convolutional neural network may be adjusted based on the loss function, thereby training the second fully convolutional neural network.

In the embodiment, the second fully convolutional neural network may be a V-Net fully convolutional neural network.

With the embodiment, the center point of each vertebra in spine bones included in the image data is located through a first fully convolutional neural network. The category of each vertebra in spine bones included in the image data is determined through a second fully convolutional neural network. That is, the center point of each vertebra is determined by processing local information of the image data through the first fully convolutional neural network, and the category of each vertebra is determined by processing global information of the image data through the second fully convolutional neural network. On one hand, compared to a manner of manually selecting a feature, feature identification, feature selection, and feature categorization may be performed automatically on the image data via a fully convolutional neural network (including the first fully convolutional neural network and the second fully convolutional neural network), improving system performance, improving accuracy in locating a center point of a vertebra. On the other hand, each pixel may be categorized using the fully convolutional neural network. That is, with the fully convolutional neural network, training efficiency may be improved by taking advantage of a spatial relation between the vertebrae, specifically by processing global information of the image data through the second fully convolutional neural network and training the second fully convolutional neural network according to a spatial relation among respective vertebrae in spine bones, improving network performance.

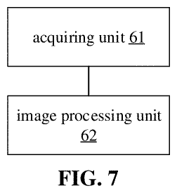

Embodiments herein further provide a device for image processing. FIG. 7 is a diagram of a structure of a device for image processing according to an exemplary embodiment herein. As shown in FIG. 7, the device includes an acquiring unit 61 and an image processing unit 62.

The acquiring unit 61 is adapted to acquiring image data including a target object. The target object includes at least one sub-object.

The image processing unit 62 is adapted to acquiring target image data by processing the image data based on a fully convolutional neural network. The target image data include at least a center point of each sub-object in the target object.

As an implementation, the image processing unit 62 may be adapted to acquiring the target image data by processing the image data based on a first fully convolutional neural network. The target image data may include the center point of the each sub-object in the target object.

As another implementation, the image processing unit 62 may be adapted to: acquiring first image data by processing the image data based on a first fully convolutional neural network, the first image data including the center point of the each sub-object in the target object; and acquiring second image data by processing the image data and the first image data based on a second fully convolutional neural network. The second image data may be for indicating a category of the each sub-object in the target object.

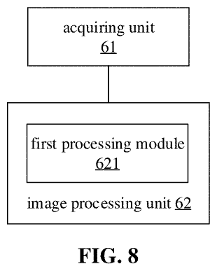

In an optional embodiment herein, as shown in FIG. 8, the image processing unit 62 may include a first processing module 621 adapted to: acquiring first displacement data corresponding to a pixel in the image data by processing the image data based on the first fully convolutional neural network, the first displacement data representing a displacement between the pixel and a center point of a first sub-object closest to the pixel; determining an initial location of the center point of the first sub-object closest to the pixel based on the first displacement data and location data of the pixel, the first sub-object being any sub-object in the at least one sub-object; acquiring initial locations of the center point of the first sub-object corresponding to at least some pixels in the image data; determining a count of occurrences of each of the initial locations; and determining the center point of the first sub-object based on an initial location with a maximal count.

In an optional embodiment herein, the first processing module 621 may be adapted to: acquiring at least one first pixel by filtering at least one pixel in the image data based on a first displacement distance corresponding to the at least one pixel, a distance between the at least one first pixel and a center point of a first sub-object closest to the at least one pixel meeting a specified condition; and determining the initial location of the center point of the first sub-object based on first displacement data corresponding to the at least one first pixel and location data of the at least one first pixel.

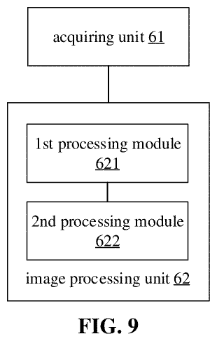

In an optional embodiment herein, as shown in FIG. 9, the image processing unit 62 may include a second processing module 622 adapted to: acquiring the target image data by merging the image data and the first image data; acquiring a probability of a category of a sub-object to which a pixel in the target image data belongs by processing the target image data based on the second fully convolutional neural network; determining a category of the sub-object corresponding to a maximal probability as the category of the sub-object to which the pixel belongs; and acquiring the second image data based on the category of the sub-object to which the pixel in the target image data belongs.

In an optional embodiment herein, the second processing module 622 may be adapted to: acquiring a probability of a category of a sub-object to which a pixel belongs, the pixel corresponding to a center point of a second sub-object in the target image data, the second sub-object being any sub-object in the at least one sub-object; and determining, as the category of the second sub-object, a category of a second sub-object corresponding to a maximal probability.

In an optional embodiment herein, the image processing unit 62 may be adapted to: acquiring third image data by performing down-sampling on the image data; and acquiring the second image data by processing the third image data and the first image data based on the second fully convolutional neural network.

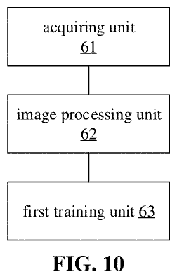

In an optional embodiment herein, as shown in FIG. 10, the device may further include a first training unit 63 adapted to: acquiring first sample image data including the target object, and first label data corresponding to the first sample image data, the first label data being for indicating the center point of the each sub-object in the target object in the first sample image data; and training the first fully convolutional neural network according to the first sample image data and the first label data corresponding to the first sample image data.

In the embodiment, the first training unit 63 may be adapted to: acquiring initial image data by processing the first sample image data according to the first fully convolutional neural network, the initial image data including an initial center point of the each sub-object in the target object in the first sample image data; and training the first fully convolutional neural network by determining a loss function based on the initial image data and the first label data and adjusting a parameter of the first fully convolutional neural network based on the loss function.

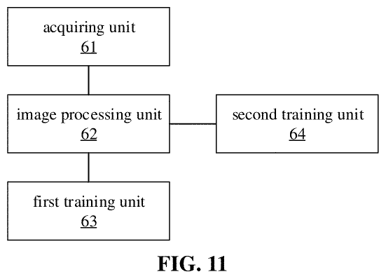

In an optional embodiment herein, as shown in FIG. 11, the device may further include a second training unit 64 adapted to: acquiring first sample image data comprising the target object, second sample image data relating to the first sample image data, and second label data corresponding to the first sample image data, the second sample image data including the center point of the each sub-object in the target object in the first sample image data, the second label data being for indicating the category of the each sub-object in the target object in the first sample image data; and training the second fully convolutional neural network based on the first sample image data, the second sample image data, and the second label data.

Optionally, the second training unit 64 may be adapted to: acquiring third sample image data by performing down-sampling on the first sample image data; and training the second fully convolutional neural network based on the third sample image data, the second sample image data, and the second label data.

In the embodiment, the target object may include spine bones. The spine bones may include at least one vertebra.

In embodiments herein, the acquiring unit 61. the image processing unit 62 (including the first processing module 621 and the second processing module 622), the first training unit 63, and the second training unit 64 in the device may all be implemented by a Central Processing Unit (CPU), a Digital Signal Processor (DSP), a Micro Processing Unit (MPU), or a Field-Programmable Gate Array (FPGA).

Note that division of the functional modules in implementing the function of the device for image processing herein is merely illustrative. In application, the function may be allocated to be carried out by different functional modules as needed. That is, a content structure of the equipment may be divided into different functional modules for carrying out all or part of the function. In addition, the method and device for image processing herein belong to one concept. Refer to the method embodiments for implementation of the device, which is not repeated here.

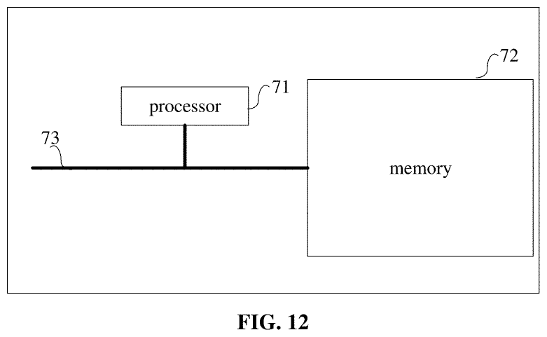

Embodiments herein further provide electronic equipment. FIG. 12 is a diagram of a structure of electronic equipment according to an exemplary embodiment herein. As shown in FIG. 12, the electronic equipment includes memory 72, a processor 71, and a computer program stored on the memory 72 and executable by the processor 71. When executing the computer program, the processor 71 implements steps of a method herein.

In the embodiment, various components in the electronic equipment may be coupled together through a bus system 73. Understandably, the bus system 73 is used for implementing connection and communication among these components. In addition to a data bus, the bus system 73 may further include a power bus, a control bus, and a status signal bus. However, for clarity of description, various buses are marked as the bus system 73 in FIG. 12.

Understandably, memory 72 may be volatile and/or non-volatile memory. The non-volatile memory may be Read Only Memory (ROM), Programmable Read-Only Memory (PROM), Erasable Programmable Read-Only Memory (EPROM), Electrically Erasable Programmable Read-Only Memory (EEPROM), ferromagnetic random access memory (FRAM), flash memory, magnetic surface memory, CD-ROM, or Compact Disc Read-Only Memory (CD-ROM). The magnetic surface memory may be a disk storage or a tape storage. The volatile memory may be Random Access Memory (RAM) serving as an external cache. By way of exemplary instead of restrictive description, there may be many forms of RAM available, such as Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM), Direct Rambus Random Access Memory (DRRAM), etc. The memory 72 herein is intended to include, but is not limited to, these and any other memory of suitable types.

A method herein may be applied to a processor 71, or implemented by the processor 71. The processor 71 may be an integrated circuit chip capable of signal processing. In implementation, a step of the method may be carried out via an integrated logic circuit of hardware in the processor 71 or instructions in form of software. The processor 71 may be a general-purpose processor, a Digital Signal Processor (DSP), or another programmable logic device, a discrete gate, or a transistor logic device, a discrete hardware component, etc. The processor 71 may implement or execute various methods, steps, and logical block diagrams herein. A general-purpose processor may be a microprocessor or any conventional processor. A step of the method disclosed herein may be directly embodied as being carried out by a hardware decoding processor, or by a combination of hardware and software modules in the decoding processor. A software module may be located in a storage medium. The storage medium may be located in the memory 72. The processor 71 may read information in the memory 72, and combine it with hardware thereof to perform a step of a method herein.

In an exemplary embodiment, electronic equipment may be implemented by one or more Application Specific Integrated Circuits (ASIC), Digital Signal Processors (DSP), Programmable Logic Devices (PLD), Complex Programmable Logic Devices (CPLD), Field-Programmable Gate Arrays (FPGA), general-purpose processors, controllers, Micro Controller Units (MCU), microprocessors, or other electronic components, to implement a method herein.

Embodiments herein further provide a computer program, including a computer-readable code which, when executed in electronic equipment, allows a processor in the electronic equipment to implement a method herein.

Embodiments herein further provide a computer-readable storage medium, having stored thereon a computer program which, when executed by a processor, implements steps of a method herein.

In embodiments provided herein, it should be understood that a device, equipment, and a method disclosed may be implemented in other ways. An aforementioned device embodiment is but illustrative. For example, division of the units is only a division of logic functions. There may be another division in actual implementation. For example, multiple units or components may be be combined, or integrated into another system, or some features may be omitted or not implemented. In addition, the coupling, or direct coupling or communicational connection among the components illustrated or discussed herein may be implemented through indirect coupling or communicational connection among some interfaces, equipment, or units, and may be electrical, mechanical, or in other forms.

The units described as separate components may or may not be physically separated. Components shown as units may be or may not be physical units. They may be located in one place, or distributed on multiple network units. Some or all of the units may be selected to achieve the purpose of a solution of the present embodiments as needed.

In addition, various functional units in each embodiment of the subject disclosure may be integrated in one processing unit, or exist as separate units respectively; or two or more such units may be integrated in one unit. The integrated unit may be implemented in form of hardware, or hardware plus software functional unit(s).

A skilled person in the art may understand that all or part of the steps of the embodiments may be implemented by instructing a related hardware through a program, which program may be stored in a (non-transitory) computer-readable storage medium and when executed, execute steps including those of the embodiments. The computer-readable storage medium may be various media that can store program codes, such as mobile storage equipment, Read Only Memory (ROM), RAM, a magnetic disk, a CD, and/or the like.

When implemented in form of a software functional module and sold or used as an independent product, an integrated module herein may also be stored in a (non-transitory) computer-readable storage medium. Based on such an understanding, the essential part or a part contributing to prior art of the technical solution of an embodiment of the present disclosure may appear in form of a software product, which software product is stored in storage media, and includes a number of instructions for allowing computer equipment (such as a personal computer, a server, network equipment, and/or the like) to execute all or part of the methods in various embodiments herein. The storage media include various media that can store program codes, such as mobile storage equipment, ROM, RAM, a magnetic disk, a CD, and/or the like.

What described are but embodiments herein and are not intended to limit the scope of the subject disclosure. Any modification, equivalent replacement, and/or the like made within the technical scope of the subject disclosure, as may occur to a person having ordinary skill in the art, shall be included in the scope of the subject disclosure. The scope of the subject disclosure thus should be determined by the claims.

What is claimed is:

1. A method for image processing, comprising:
acquiring image data comprising a target object, the target object comprising at least one sub-object; and
acquiring target image data by processing the image data based on a fully convolutional neural network, the target image data comprising at least a center point of each sub-object in the target object.

2. The method of claim 1, wherein acquiring the target image data by processing the image data based on the fully convolutional neural network comprises:
acquiring the target image data by processing the image data based on a first fully convolutional neural network, the target image data comprising the center point of the each sub-object in the target object.

3. The method of claim 1, wherein acquiring the target image data by processing the image data based on the fully convolutional neural network comprises:
acquiring first image data by processing the image data based on a first fully convolutional neural network, the first image data comprising the center point of the each sub-object in the target object; and
acquiring second image data by processing the image data and the first image data based on a second fully convolutional neural network, the second image data being for indicating a category of the each sub-object in the target object.

4. The method of claim 2, wherein processing the image data based on the first fully convolutional neural network comprises:
acquiring first displacement data corresponding to a pixel in the image data by processing the image data based on the first fully convolutional neural network, the first displacement data representing a displacement between the pixel and a center point of a first sub-object closest to the pixel;
determining an initial location of the center point of the first sub-object closest to the pixel based on the first displacement data and location data of the pixel, the first sub-object being any sub-object in the at least one sub-object; and
acquiring initial locations of the center point of the first sub-object corresponding to at least some pixels in the image data; determining a count of occurrences of each of the initial locations; and determining the center point of the first sub-object based on an initial location with a maximal count.

5. The method of claim 4, further comprising: before determining the initial location of the center point of the first sub-object closest to the pixel based on the first displacement data and the location data of the pixel,
acquiring at least one first pixel by filtering at least one pixel in the image data based on a first displacement distance corresponding to the at least one pixel, a distance between the at least one first pixel and a center point of a first sub-object closest to the at least one pixel meeting a specified condition,
wherein determining the initial location of the center point of the first sub-object closest to the pixel based on the first displacement data and the location data of the pixel comprises:
determining the initial location of the center point of the first sub-object based on first displacement data corresponding to the at least one first pixel and location data of the at least one first pixel.

6. The method of claim 3, wherein acquiring the second image data by processing the image data and the first image data based on the second fully convolutional neural network comprises:
acquiring the target image data by merging the image data and the first image data;
acquiring a probability of a category of a sub-object to which a pixel in the target image data belongs by processing the target image data based on the second fully convolutional neural network; determining a category of the sub-object corresponding to a maximal probability as the category of the sub-object to which the pixel belongs; and
acquiring the second image data based on the category of the sub-object to which the pixel in the target image data belongs.

7. The method of claim 6, wherein acquiring the probability of the category of the sub-object to which the pixel in the target image data belongs and determining the category of the sub-object corresponding to the maximal probability as the category of the sub-object to which the pixel belongs comprises:
acquiring a probability of a category of a sub-object to which a pixel belongs, the pixel corresponding to a center point of a second sub-object in the target image data, the second sub-object being any sub-object in the at least one sub-object; and
determining, as the category of the second sub-object, a category of a second sub-object corresponding to a maximal probability.

8. The method of claim 3, wherein acquiring the second image data by processing the image data and the first image data based on the second fully convolutional neural network comprises:
acquiring third image data by performing down-sampling on the image data; and
acquiring the second image data by processing the third image data and the first image data based on the second fully convolutional neural network.

9. The method of claim 2, wherein the first fully convolutional neural network is trained by:
acquiring first sample image data comprising the target object, and first label data corresponding to the first sample image data, the first label data being for indicating the center point of the each sub-object in the target object in the first sample image data; and
training the first fully convolutional neural network according to the first sample image data and the first label data corresponding to the first sample image data.

10. The method of claim 9, wherein training the first fully convolutional neural network according to the first sample image data and the first label data corresponding to the first sample image data comprises:
acquiring initial image data by processing the first sample image data according to the first fully convolutional neural network, the initial image data comprising an initial center point of the each sub-object in the target object in the first sample image data; and
training the first fully convolutional neural network by determining a loss function based on the initial image data and the first label data and adjusting a parameter of the first fully convolutional neural network based on the loss function.

11. The method of claim 3, wherein the second fully convolutional neural network is trained by:
acquiring first sample image data comprising the target object, second sample image data relating to the first sample image data, and second label data corresponding to the first sample image data, the second sample image data comprising the center point of the each sub-object in the target object in the first sample image data, the second label data being for indicating the category of the each sub-object in the target object in the first sample image data; and
training the second fully convolutional neural network based on the first sample image data, the second sample image data, and the second label data.

12. The method of claim 11, training the second fully convolutional neural network based on the first sample image data, the second sample image data, and the second label data comprises:
acquiring third sample image data by performing down-sampling on the first sample image data; and
training the second fully convolutional neural network based on the third sample image data, the second sample image data, and the second label data.

13. The method of claim 1, wherein the target object comprises spine bones, the spine bones comprising at least one vertebra.

14. Electronic equipment, comprising memory, a processor, and a computer program stored on the memory and executable by the processor, wherein when executing the computer program, the processor implements:
acquiring image data comprising a target object, the target object comprising at least one sub-object; and
acquiring target image data by processing the image data based on a fully convolutional neural network, the target image data comprising at least a center point of each sub-object in the target object.

15. The electronic equipment of claim 14, wherein the processor is configured to acquire the target image data by processing the image data based on the fully convolutional neural network by:
acquiring the target image data by processing the image data based on a first fully convolutional neural network, the target image data comprising the center point of the each sub-object in the target object.

16. The electronic equipment of claim 14, wherein the processor is configured to acquire the target image data by processing the image data based on the fully convolutional neural network by:
acquiring first image data by processing the image data based on a first fully convolutional neural network, the first image data comprising the center point of the each sub-object in the target object; and
acquiring second image data by processing the image data and the first image data based on a second fully convolutional neural network, the second image data being for indicating a category of the each sub-object in the target object.

17. The electronic equipment of claim 15, wherein the processor is configured to process the image data based on the first fully convolutional neural network by:
acquiring first displacement data corresponding to a pixel in the image data by processing the image data based on the first fully convolutional neural network, the first displacement data representing a displacement between the pixel and a center point of a first sub-object closest to the pixel;
determining an initial location of the center point of the first sub-object closest to the pixel based on the first displacement data and location data of the pixel, the first sub-object being any sub-object in the at least one sub-object; and
acquiring initial locations of the center point of the first sub-object corresponding to at least some pixels in the image data; determining a count of occurrences of each of the initial locations; and determining the center point of the first sub-object based on an initial location with a maximal count.

18. The electronic equipment of claim 16, wherein the processor is configured to acquire the second image data by processing the image data and the first image data based on the second fully convolutional neural network by:
acquiring the target image data by merging the image data and the first image data;
acquiring a probability of a category of a sub-object to which a pixel in the target image data belongs by processing the target image data based on the second fully convolutional neural network; determining a category of the sub-object corresponding to a maximal probability as the category of the sub-object to which the pixel belongs; and
acquiring the second image data based on the category of the sub-object to which the pixel in the target image data belongs.

19. The electronic equipment of claim 14, wherein the target object comprises spine bones, the spine bones comprising at least one vertebra.

20. A non-transitory computer-readable storage medium, having stored thereon a computer program which, when executed by a processor, implements:
acquiring image data comprising a target object, the target object comprising at least one sub-object; and
acquiring target image data by processing the image data based on a fully convolutional neural network, the target image data comprising at least a center point of each sub-object in the target object.
